(19) United States
(12) Patent Application Publication
(10) Pub. No.: US 2025/0309238 A1
(43) Pub. Date: Oct. 2, 2025

(54) POSITIVE ELECTRODE STRUCTURE AND MANUFACTURING METHOD THEREOF

(71) Applicant: HONDA MOTOR CO., LTD., Tokyo (JP)

(72) Inventors: Akihiro TAGUCHI, Saitama (JP); Masahiro HOKAZONO, Saitama (JP)

(21) Appl. No.: 19/046,931

(22) Filed: Feb. 6, 2025

(30) Foreign Application Priority Data
Mar. 28, 2024 (JP) 2024-053989

(51) Int. Cl. H01M 4/1391; H01M 4/02; H01M 4/04; H01M 4/525; H01M 4/62; H01M 10/0525

(52) U.S. Cl. CPC H01M 4/1391; H01M 4/0404; H01M 4/0435; H01M 4/525; H01M 4/623; H01M 10/0525; H01M 2004/028

(57) ABSTRACT

A positive electrode structure according to the present invention includes: a foil-shaped current collector; and positive electrode active material layers provided on both surfaces of the current collector, wherein each of the positive electrode active material layers has a central portion containing an active material and an insulating frame disposed on an outer periphery of the central portion and containing an insulating material, the insulating frame covers a surface near an outer edge of the current collector and at least a part of a side end surface of the current collector, and the side end surface of the current collector covered with the insulating frame is covered with the insulating frame of the positive electrode active material layer provided on one of the surfaces of the current collector and the insulating frame of the positive electrode active material layer provided on the other of the surfaces of the current collector.

### BACKGROUND

### Technical Field

The present invention relates to a positive electrode structure for a secondary battery and a manufacturing method of a positive electrode structure for a secondary battery.

### Related Art

In recent years, research and development on secondary batteries that contribute to energy efficiency has been conducted in order for more people to be able to access affordable, reliable, sustainable, and advanced energy. Among them, an all-solid-state battery has many advantages such as high energy density and safety as compared with the conventional secondary battery, and is expected to be utilized as a power source for, for example, an electric vehicle, a hybrid electric vehicle, or the like.

The all-solid-state battery includes a positive electrode active material layer, a negative electrode active material layer, and a solid electrolyte layer disposed between these active material layers. The solid electrolyte layer also serves as a separator, and prevents a short circuit between the positive electrode and the negative electrode. Current collectors for connecting to external electrodes are provided in the positive electrode active material layer and the negative electrode active material layer, respectively, and as such current collectors, for example, metal foils such as aluminum foils and copper foils may be used.

For example, in an all-solid-state battery having a structure in which a solid electrolyte layer and a negative electrode active material layer are respectively disposed on both surfaces of a positive electrode active material layer, negative electrode current collectors of the negative electrode active material layers respectively laminated above and below the positive electrode active material layer are bundled into one and connected to an electrode. In such a structure, the negative electrode current collectors may come close to the positive electrode current collector and short-circuit due to deformation of the metal foil or the like when the negative electrode current collectors are bundled.

In view of such a problem, in an all-solid-state battery having a solid electrolyte layer using a base material as disclosed in JP 2023-151100 A, for example, it is possible to adopt a structure in which a solid electrolyte layer whose strength is increased by putting the base material and which becomes self-standing protrudes in the same direction as a direction in which negative electrode current collectors protrude (direction intersecting a laminating direction). In this case, the protruding solid electrolyte layer functions like an eave, and even when the negative electrode current collectors are bent and deformed when being bundled, the negative electrode current collectors can be prevented from coming into contact with the positive electrode current collector by being blocked by the protruding solid electrolyte layer.

### CITATION LIST

### Patent Literature

Patent Literature 1: JP 2023-151100 A

### SUMMARY

In general batteries including all-solid-state batteries, it is required to reduce the thickness of each member in order to increase the energy density. In the case of a structure in which a base material is used for the solid electrolyte layer as in JP 2023-151100 A described above, the thickness of the base material may be a bottleneck in reduction of the thickness of the solid electrolyte layer. Therefore, in order to reduce the thickness, development of an all-solid-state battery in which a base material is not used for a solid electrolyte layer is also in progress, and development of a structure capable of suppressing a short circuit between current collectors is also desired in such an all-solid-state battery.

The present invention has been made to solve the above problems, and an object of the present invention is to provide a positive electrode structure capable of suppressing a short circuit of a positive electrode current collector without using a base material for a solid electrolyte layer. This ultimately contributes to energy efficiency.

In order to achieve the above object, a positive electrode structure according to an invention of claim 1 is a positive electrode structure including: a foil-shaped current collector; and positive electrode active material layers provided on both surfaces of the current collector, wherein each of the positive electrode active material layers has a central portion containing an active material and an insulating frame disposed on an outer periphery of the central portion and containing an insulating material having electrical insulation properties, the insulating frame covers a surface near an outer edge of the current collector and at least a part of a side end surface of the current collector, and the side end surface of the current collector covered with the insulating frame is covered with the insulating frame of the positive electrode active material layer provided on one of the surfaces of the current collector and the insulating frame of the positive electrode active material layer provided on the other of the surfaces of the current collector.

In the positive electrode structure, the positive electrode active material layer includes a central portion containing an active material and an insulating frame disposed on an outer periphery of the central portion, and the insulating frame covers a surface near an outer edge of the current collector and at least a part of a side end surface of the current collector. As described above, since the insulating frame provided as a part of the positive electrode active material layer also covers the surface in the vicinity of the outer edge and at least a part of the side end surface of the current collector, the contact between the negative electrode current collector and the positive electrode current collector can be suppressed by the insulating frame covering the side end surface of the positive electrode current collector on the same side as the direction in which the negative electrode current collector protrudes. Therefore, in the all-solid-state battery using the positive electrode structure, it is possible to suppress a short circuit of the positive electrode current collector without using a base material for the solid electrolyte layer.

In addition, the side end surface of the current collector covered with the insulating frame of the positive electrode active material layer is covered with the insulating frames provided respectively on one and the other of the surfaces of the current collector. As described above, by the respective insulating frames provided on the both surfaces of the current collector covering the side end surface of the current collector, it is possible to efficiently cover the side end surfaces of the current collector.

An invention according to claim 2 is the positive electrode structure according to claim 1, wherein the insulating material of the insulating frame is alumina.

According to this configuration, the insulating frame in which the insulating material is alumina can be suitably used.

An invention according to claim 3 is the positive electrode structure according to claim 1, wherein an elongation percentage of the insulating frame provided on the surfaces of the current collector is larger than an elongation percentage of the current collector.

According to this configuration, since the insulator frame provided on the surface of the current collector has a larger elongation percentage than the current collector, the side end surface of the current collector can be suitably covered with the insulating frame provided on the surface near the outer edge of the current collector.

A manufacturing method of a positive electrode structure according to an invention of claim 4 is a manufacturing method of the positive electrode structure according to claim 1, the manufacturing method including: a first coating step of coating both surfaces of a metal foil sheet with a slurry of a positive electrode mixture containing the active material, a metal foil sheet being a raw material of the current collector; a second coating step of coating a region along an outer periphery of the positive electrode mixture of the metal foil sheet with a slurry of the insulating material, at least a part of the region being along an outer edge of the metal foil sheet; and a pressing step of roll-pressing the metal foil sheet coated with the slurry of the positive electrode mixture and the slurry of the insulating material at a pressing pressure from 800 MPa to 1200 MPa.

According to the manufacturing method of a positive electrode structure, after a region along an outer periphery of the positive electrode mixture of the metal foil sheet, at least a part of which region is along an outer edge of the metal foil sheet, is coated with a slurry of the insulating material, roll-pressing is performed at a pressing pressure from 800 MPa to 1200 MPa. As a result, the insulating material applied to the region along the outer edge of the metal foil sheet is rolled by the subsequent roll-pressing, and the rolled insulating material covers the side end surface of the metal foil sheet. Thereafter, by using a rotary die cutter, a trim cutter or the like, the metal foil sheet is cut into a desired shape so as to include the side end surface covered with the insulating material as it is, and thus a positive electrode structure in which the surface in the vicinity of the outer edge and at least a part of the side end surface of the current collector are covered with an insulating frame is obtained.

Therefore, in the all-solid-state battery using the positive electrode structure manufactured by this manufacturing method, the contact between the negative electrode current collector and the positive electrode current collector can be suppressed, by covering the side end surface of the positive electrode current collector on the same side as the direction in which the negative electrode current collector protrudes with the insulating frame. Therefore, a short circuit of the positive electrode current collector can be suppressed without using a base material for the solid electrolyte layer. An invention according to claim 5 is the manufacturing method of a positive electrode structure according to claim 4, wherein the slurry of the insulating material contains alumina, a styrene-butadiene rubber-based or polyvinylidene fluoride-based binder, and butyl butyrate.

According to this configuration, the slurry of the insulating material containing alumina, a styrene-butadiene rubber (SBR)-based or polyvinylidene fluoride (PVDF)-based binder, and butyl butyrate can be suitably used.

An invention according to claim 6 is the manufacturing method of a positive electrode structure according to claim 4 or 5, wherein an elongation percentage of the slurry of the insulating material in the pressing step is larger than an elongation percentage of the metal foil sheet.

According to this configuration, the side end surface of the metal foil sheet can be suitably covered with the slurry of the insulating material applied to the region along the outer edge of the metal foil sheet.

A secondary battery according to the invention of claim 7 includes the positive electrode structure according to claim 1 as a positive electrode.

According to this configuration, in the positive electrode structure, since the insulating frame provided as a part of the positive electrode active material layer also covers the surface in the vicinity of the outer edge and at least a part of the side end surface of the current collector, the contact between the negative electrode current collector and the positive electrode current collector can be suppressed by the insulating frame covering the side end surface of the positive electrode current collector on the same side as the direction in which the negative electrode current collector protrudes. Therefore, in the secondary battery having this configuration, a short circuit of the positive electrode current collector can be suppressed.

An invention according to claim 8 is the secondary battery according to claim 7, wherein the secondary battery is an all-solid-state battery.

According to this configuration, in the all-solid-state battery, it is possible to suppress a short circuit of the positive electrode current collector without using a base material for the solid electrolyte layer.

An invention according to claim 9 is the secondary battery according to claim 7 or 8, wherein the secondary battery is a lithium metal secondary battery.

According to this configuration, in the lithium metal secondary battery having the lithium metal layer in the negative electrode, the short circuit of the positive electrode current collector can be suppressed.

### BRIEF DESCRIPTION OF DRAWINGS

FIG. 1 is a sectional view schematically illustrating an all-solid-state battery including a positive electrode structure according to an embodiment of the present invention;

FIGS. 2A and 2B are views for explanation of a coating step and a pressing step in a manufacturing method of the positive electrode structure according to the embodiment;

FIGS. 3A and 3B are views for explanation of a cutting step in the manufacturing method of the positive electrode structure according to the embodiment;

FIG. 4 is an optical micrograph showing an example of the positive electrode structure according to the present invention;

FIG. 5 is an optical micrograph showing a comparative example of a positive electrode structure; and

FIG. 6 is an optical micrograph showing a comparative example of a positive electrode structure.

### DETAILED DESCRIPTION

Hereinafter, embodiments of a positive electrode structure according to the present invention and an all-solid-state battery using the same will be described with reference to the drawings. Note that the drawings used in the following description may be partially enlarged or reduced in order to facilitate the description, and the size and ratio of each component are not limited to those illustrated.

### [All-Solid-State Battery]

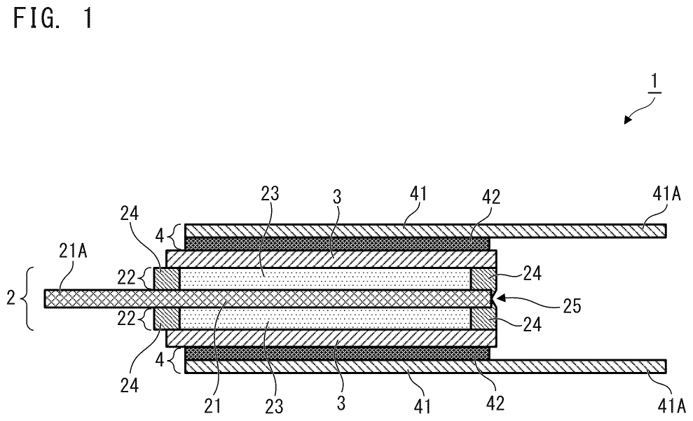

FIG. 1 is a sectional view schematically illustrating an all-solid-state battery 1 including a positive electrode structure 2 according to an embodiment. The all-solid-state battery 1 is an example of a secondary battery to which the positive electrode structure 2 according to the present embodiment can be applied, and the positive electrode structure 2 can also be used for a secondary battery using a liquid electrolyte.

As shown in the drawing, the all-solid-state battery 1 is an all-solid-state lithium metal battery including the positive electrode structure 2, solid electrolyte layers 3 respectively laminated on both surfaces of the positive electrode structure 2, and negative electrode structures 4 respectively laminated on surfaces of the solid electrolyte layers 3 on a side opposite to the positive electrode structure 2, and a lithium metal layer is disposed on a negative electrode.

In the following description, the side end surface of each component means an end surface in a direction perpendicular to the laminating direction of the components.

### [Positive Electrode Structure]

The positive electrode structure 2 includes a positive electrode current collector 21 which is a foil-shaped current collector and a positive electrode active material layer 22.

The positive electrode current collector 21 has a function of collecting current of the positive electrode structure 2. The positive electrode current collector 21 is a foil-shaped member made of an electrode material having conductivity, and can be made of, for example, aluminum (Al), nickel (Ni), stainless steel, or an alloy thereof. In the present embodiment, an aluminum foil is used as the positive electrode current collector 21.

The positive electrode current collector 21 has a positive electrode projecting portion 21A for connecting to a tab lead or a terminal electrode at one of side end portions, and the positive electrode projecting portion 21A projects laterally (in a direction intersecting the laminating direction) by a predetermined length.

The positive electrode active material layer 22 includes a central portion 23 containing a positive electrode active material and an insulating frame 24 provided along an outer periphery of the central portion 23.

The central portion 23 is configured by a positive electrode mixture including a positive electrode active material, a solid electrolyte, a conductive auxiliary agent, a binder, and the like. The positive electrode active material is not particularly limited as long as it is a material that can reversibly occlude and release lithium ions and can transport electrons, and examples thereof include composite oxides such as lithium cobalt oxide (LiCoO₂), lithium nickel oxide (LiNiO₂), lithium manganese oxide (LiMn₂O₄), solid solution oxide (Li₂MnO₃—LiMO₂ (M=Co, Ni, etc.)), lithium-manganese-nickel-cobalt oxide (LiNi_{1/3}Mn_{1/3}Co_{1/3}O₂), and olivine type lithium phosphorus oxide (LiFePO₄). These positive electrode active materials may be used singly or in combination of two or more kinds thereof.

The solid electrolyte contained in the central portion 23 may be of the same type as or different from the solid electrolyte contained in the solid electrolyte layer 3 described later.

Examples of the conductive auxiliary agent that can be blended in the central portion 23 include carbon black, acetylene black, Ketjen black, and carbon fiber.

Examples of the binder that can be blended in the central portion 23 include styrene butadiene rubber (SBR), polyvinylidene fluoride (PVDF), and polytetrafluoroethylene.

The insulating frame 24 is disposed in close contact with the side end surface of the central portion 23 with substantially the same thickness as the central portion 23 so as to cover the entire side end surface of the central portion 23. The insulating frame 24 is provided using an insulating material having electrical insulation properties, and prevents a short circuit of the central portion 23 containing the positive electrode active material. Examples of the insulating material used for the insulating frame 24 include a ceramic material such as alumina (AL₂O₃), or a resin material such as a polyolefin-based resin, a vinyl-based resin, an acryl-based resin, a polyamide-based resin, a fluorine-based resin, and a composite resin thereof. In the present embodiment, alumina is used as an insulating material as a material having high insulation properties, abrasion resistance, chemical stability, cost properties, and the like.

The insulating frame 24 is formed by containing a binder in an insulating material as described later. The insulating frame 24 is provided to have a predetermined elongation percentage by adjusting the viscosity by adjusting the composition and content of the binder. With such a configuration, the insulating frame 24 covers not only the central portion 23 but also a surface near an outer edge of the positive electrode current collector 21, and a side end surface of the positive electrode current collector 21 on a side opposite to the positive electrode projecting portion 21A.

Examples of the binder that can be blended in the insulating material include styrene butadiene rubber (SBR), polyvinylidene fluoride (PVDF), and polytetrafluoroethylene.

As shown in FIG. 1, both the insulating frame 24 disposed on one surface (for example, the upper surface in the drawing) of the positive electrode current collector 21 and the insulating frame 24 disposed on the other surface (for example, a lower surface in the drawing) of the positive electrode current collector 21 extend toward one end surface of the positive electrode current collector 21 and cover the end surface, and thus an end surface covering portion 25 is provided. The end surface covering portion 25 covers a part of the side end surface of the positive electrode current collector 21, so that the positive electrode current collector 21 is prevented from coming into contact with another electrode or the like to cause a short circuit.

### [Solid Electrolyte Layer]

As shown in FIG. 1, the solid electrolyte layer 3 is a layer disposed between the positive electrode structure 2 and the negative electrode structure 4, and contains a solid electrolyte.

Examples of the solid electrolyte include sulfide-based solid electrolyte materials, oxide-based solid electrolyte materials, nitride-based solid electrolyte materials, and halide-based solid electrolyte materials. Examples of the sulfide-based solid electrolyte material include LPS-based halogen (Cl, Br, I), Li₂S—P₂S₅, Li₂S—P₂S₅—LiI, and the like. Note that the above description of “Li₂S—P₂S₅” means a sulfide-based solid electrolyte material obtained using a raw material composition containing Li₂S and P₂S₅, and the same applies to other descriptions. Examples of the oxide-based solid electrolyte material include NASICON-type oxide, garnet-type oxide, and perovskite-type oxide. Examples of the NASICON type oxide include oxides containing Li, Al, Ti, P, and O (for example, Li_{1.5}Al_{0.5}Ti_{1.5}(PO₄)₃). Examples of the garnet type oxide include oxides containing Li, La, Zr, and O (for example, Li₇La₃Zr₂O₁₂). Examples of the perovskite-type oxide include oxides containing Li, La, Ti, and O (for example, LiLaTiO₃).

The solid electrolyte layer 3 is preferably includes a solid electrolyte of equal to or greater than 90 parts by mass and equal to or less than 97 parts by mass and a binder of equal to or greater than 3 parts by mass and equal to or less than 10 parts by mass. In addition, a thickness of the solid electrolyte layer 3 is not particularly limited since various aspects are used depending on the specifications of the cell, but is preferably, for example, equal to or greater than 10 μm and equal to or less than 50 μm. The form of the solid electrolyte is not particularly limited, but may be, for example, a particulate form.

### [Negative Electrode Structure]

Each of the negative electrode structures 4 includes a negative electrode current collector 41 which is a foil-shaped current collector and a negative electrode active material layer 42. The negative electrode active material layer 42 is laminated on each of the solid electrolyte layers 3. The negative electrode current collectors 41 are respectively laminated on the negative electrode active material layers 42, and provides outermost layers of the all-solid-state battery 1.

The negative electrode current collectors 41 have a function of collecting current respectively of the negative electrode structures 4. The negative electrode current collectors 41 are a foil-shaped member made of an electrode material having conductivity.

Examples of the material constituting the negative electrode current collectors 41 include copper (Cu), nickel (Ni), titanium (Ti), cobalt (Co), stainless steel, and alloys thereof. In the present embodiment, a copper foil is used as the negative electrode current collectors 41.

Each of the negative electrode current collectors 41 has a negative electrode projecting portion 41A which projects laterally in order to be connected to a tab lead or a terminal electrode at a side end portion on a side opposite to a side where the positive electrode projecting portion 21A is provided in the positive electrode structure 2.

In the present embodiment, the negative electrode projecting portions 41A of the negative electrode current collectors 41 provided on both surface sides of the positive electrode structure 2 are bundled into one and then joined to a tab lead or a terminal electrode. Therefore, there is a case where the negative electrode projecting portions 41A are deformed due to deflection or the like at the time of bundling together and move to a position close to the positive electrode structure 2. However, as described above, since the end portion of the positive electrode active material layer 22 is covered with the insulating frame 24, and the side end surface of the positive electrode current collector 21 on the negative electrode projecting portion 41A side is covered with the end surface covering portion 25 of the insulating frame 24, there is no possibility that a short circuit occurs between the negative electrode structure 4 and the positive electrode structure 2.

The negative electrode active material layer 42 contains a negative electrode active material. As the negative electrode active material, for example, a material using lithium metal or a lithium alloy alone or a mixture thereof can be used. Examples of the element for providing an alloy with lithium metal include Al, Mg, K, Na, Ca, Sr, Ba, Si, Ge, Sb, Pb, Sn, In, and Zn.

### [Manufacturing Method of All-Solid-State Battery]

Next, a manufacturing method of the all-solid-state battery 1 will be described.

The all-solid-state battery 1 of the present embodiment is manufactured by a positive electrode structure manufacturing step of manufacturing the positive electrode structure 2, a solid electrolyte layer manufacturing step of manufacturing the solid electrolyte layer 3, a negative electrode structure manufacturing step of manufacturing the negative electrode structure 4, and a laminating step of laminating the positive electrode structure 2, the solid electrolyte layer 3, and the negative electrode structure 4.

### [Positive Electrode Structure Manufacturing Step]

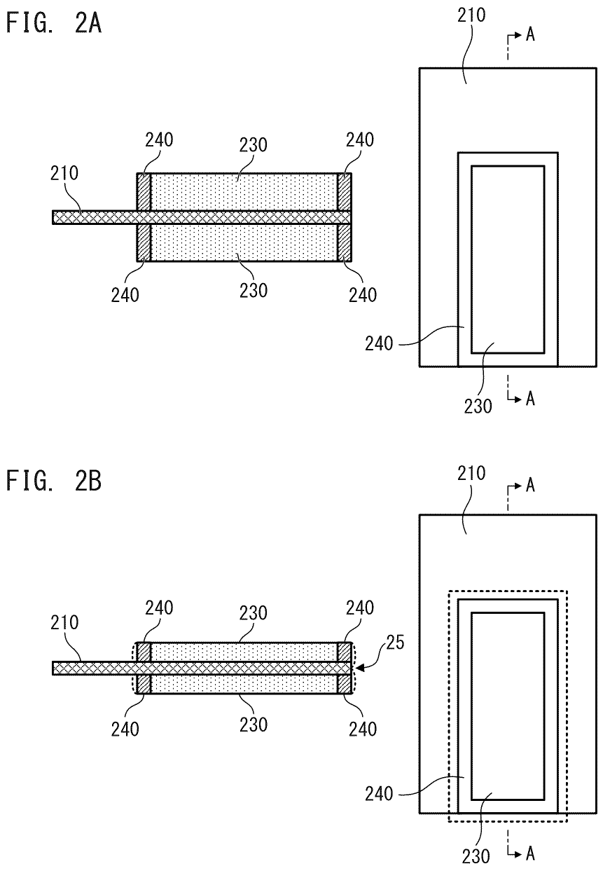

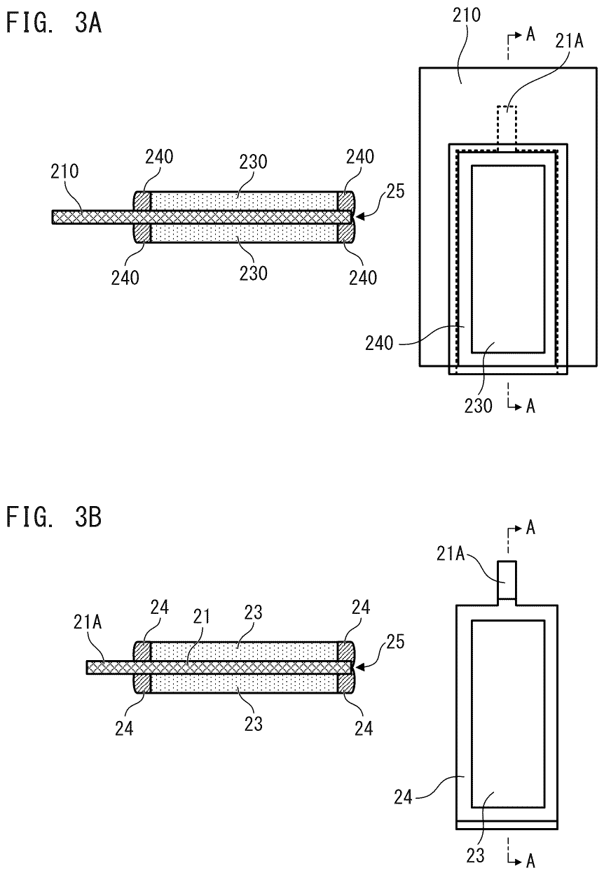

First, a manufacturing method of the positive electrode structure 2 will be described with reference to FIGS. 2 and 3. In FIGS. 2 and 3, the right view is a plan view schematically showing a region for manufacturing the positive electrode structure 2 in a metal foil sheet 210, and the left view is a schematic sectional view taken along line A-A in the right view.

First, to both surfaces of the metal foil sheet 210 as a raw material of the positive electrode current collector 21, a first coating step of applying a slurry of a positive electrode mixture 230 constituting the central portion 23, and a second coating step of applying a slurry of an insulating material 240 constituting the insulating frame 24 are performed. FIG. 2A shows a state of the metal foil sheet 210 after the first coating step and the second coating step are performed.

In the first coating step, first, the positive electrode mixture 230 constituting the central portion 23 of the positive electrode active material layer 22 (positive electrode active material, solid electrolyte, conductive auxiliary agent, binder, and the like) is added to a nonpolar solvent to prepare a slurry of the positive electrode mixture 230. Next, the obtained slurry of the positive electrode mixture 230 is applied to predetermined positions on both surfaces of the metal foil sheet 210 and then dried. The predetermined position where the slurry is applied will be described later.

Next, in the second coating step, first, alumina powder as the insulating material 240 constituting the insulating frame 24 of the present embodiment, a styrene-butadiene rubber (SBR)-based or polyvinylidene fluoride (PVDF)-based binder, and butyl butyrate are dispersed in a solvent to prepare a slurry. Next, the obtained slurry of the insulating material 240 is applied to regions along the outer periphery of the positive electrode mixture 230 on both surfaces of the metal foil sheet 210, and then dried.

Here, the positions on the metal foil sheet 210 to which the slurry of the positive electrode mixture 230 and the slurry of the insulating material 240 are applied will be described. As shown in FIG. 2A, the slurry of the positive electrode mixture 230 is applied in, for example, a rectangular shape having long sides and short sides, and the slurry of the insulating material 240 is applied in a rectangular frame shape along the outer periphery of the rectangular positive electrode mixture 230. At this time, the slurry of the insulating material 240 is applied in such a positional relationship that one of the short sides in the rectangular frame shape is disposed in a region along the outer edge of the metal foil sheet 210. Therefore, the slurry of the positive electrode mixture 230 is applied in such a positional relationship that one of the short sides is disposed at a position on the inner side (side away from the outer edge) by the width of the short side of the insulating material 240 from the outer edge of the metal foil sheet 210.

Subsequently, a pressing step of pressure-forming the metal foil sheet 210 coated with the slurry of the positive electrode mixture 230 and the slurry of the insulating material 240 is executed. The pressure-forming in the pressing step is performed using a roll press which is a pressure device. A pressing pressure by the roll press is preferably set in a range from 800 MPa to 1200 MPa.

FIG. 2B shows a state of the metal foil sheet 210 after the pressing step is performed. The viscosity of the insulating material 240 is adjusted by adjusting the composition and content of the binder, and the insulating material has a predetermined elongation percentage higher than that of the metal foil sheet 210. Therefore, the insulating material 240 is deformed by being compressed in the laminating direction by pressing, and each side extends laterally as indicated by a broken line in FIG. 2B. Here, since one of the short sides of the insulating material 240 is disposed in a region along the outer edge of the metal foil sheet 210, the insulating material 240 disposed in the region along the outer edge extends not only laterally but also in the laminating direction. As a result, the end surface covering portion 25 is formed on a part of the side end surface of the metal foil sheet 210.

Subsequently, a cutting step of cutting the pressed metal foil sheet 210 into a predetermined shape is executed. In FIG. 3A, a cutting region of metal foil sheet 210 is indicated by a broken line. A rotary die cutter or a uniaxial trim cutter is suitably used for the cutting. FIG. 3B shows the positive electrode structure 2 obtained by the cutting step. As shown in the drawing, the positive electrode projecting portion 21A is formed on the positive electrode current collector 21 by cutting.

The side end surface of the positive electrode current collector 21 on the side opposite to the positive electrode projecting portion 21A is covered with the end surface covering portion 25, and the positive electrode current collector 21 is not exposed to the outside. As a result, in the positive electrode structure 2 manufactured by the present manufacturing method, a part of the side end surface of the positive electrode current collector 21 is covered with the end surface covering portion 25 formed by the deformation of the insulating frame 24 and is not exposed to the outside, so that it is possible to suppress the positive electrode current collector from coming into contact with another electrode or the like at the side end surface and being short-circuited.

### [Solid Electrolyte Layer Manufacturing Step]

Subsequently, a manufacturing step of the solid electrolyte layer 3 will be described. The solid electrolyte layer 3 of the present embodiment is formed without using a base material or the like for thickness reduction, but it is also possible to use a solid electrolyte layer using a base material or the like.

First, the particulate solid electrolyte used for the solid electrolyte layer 3 can be produced, for example, by subjecting a mixed material obtained by treating a starting material of the solid electrolyte by a melt quenching method or a mechanical milling method to a heat treatment at a predetermined temperature and for a predetermined time, and then pulverizing the mixture.

Subsequently, a slurry of a solid electrolyte layer containing a solid electrolyte, a binder, and a predetermined dispersion medium is prepared, and applied onto, for example, a PET film whose surface has been subjected to release treatment, and dried to prepare a sheet of the solid electrolyte layer 3.

Subsequently, a manufacturing step of the negative electrode structure 4 will be described.

First, a lithium metal material or a lithium alloy material constituting the negative electrode active material layer 42 and a metal material constituting the negative electrode current collector 41 are rolled and joined, and then subjected to heat treatment and further rolled to obtain a clad material to be a material of the negative electrode structure 4.

Next, the obtained clad material is punched into a predetermined size to produce the negative electrode structure 4.

### [Laminating Step]

Subsequently, a laminating step of laminating the positive electrode structure 2, the solid electrolyte layer 3, and the negative electrode structure 4 will be described.

In the laminating step, a laminated body in which a sheet of the solid electrolyte layer 3 is disposed between the positive electrode structure 2 and the negative electrode structure 4 prepared as described above is formed, and then the laminated body is pressed in the lamination direction by press molding to be brought into close contact with each other and integrated, thereby obtaining the all-solid-state battery 1.

For the purpose of improving adhesion between the solid electrolyte layer 3 and the positive electrode structure 2 or the negative electrode structure 4, an active material having ion conductivity or an adhesive material that does not inhibit ion conductivity may be disposed at the bonding interface.

### [Examples of Positive Electrode Structure]

Next, an example of the positive electrode structure of the present invention will be described.

A slurry of the positive electrode mixture 230 was prepared using a ternary positive electrode active material composed of a nickel-cobalt-manganese composite oxide, a solid electrolyte, a binder, and a conductive auxiliary agent. Next, the obtained slurry was applied to the regions illustrated in FIG. 2 on both surfaces of the aluminum foil to be a material of the positive electrode current collector 21, and then dried.

Subsequently, a slurry of an insulating material was prepared using alumina as an insulating material, styrene-butadiene rubber (SBR) as a binder, and butyl butyrate. Next, the obtained slurry was applied to a region along the outer periphery of the positive electrode mixture described in FIG. 2, and then dried.

After drying, the aluminum foil having both surfaces coated with the positive electrode mixture and the insulating material was pressed by the roll press at a pressing pressure of 800 MPa, and then punched into a desired shape and size with a rotary die cutter to obtain a positive electrode structure.

The positive electrode structures of Comparative Example 1 and Comparative Example 2 were produced using the same positive electrode mixture and the same insulating material as in the above-described Examples. In Comparative Example 1, the positive electrode structure was cut out by a rotary die cutter after slurry coating without performing roll pressing. In Comparative Example 2, an insulating material prepared so as to have a smaller elongation percentage than in Examples was used.

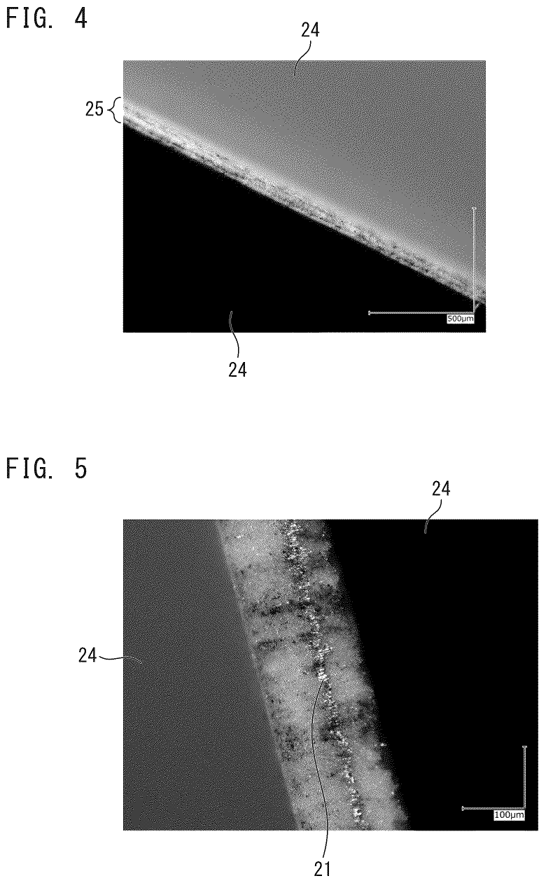

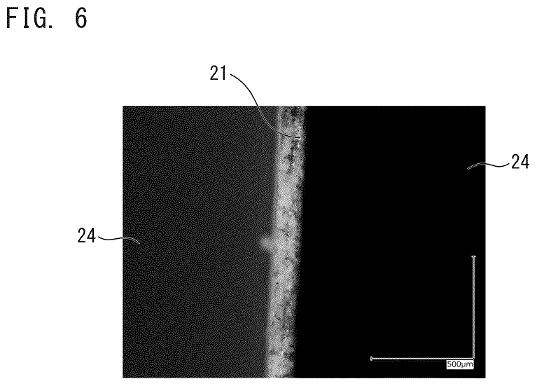

FIGS. 4 to 6 are optical micrographs showing one side end surface of the positive electrode current collector in the positive electrode structures of Example, Comparative Examples 1 and 2, respectively.

As shown in FIG. 4, it can be confirmed that in the positive electrode structure of the example, the end surface covering portion was formed on the side end surface of the positive electrode current collector, and the positive electrode current collector was covered with the insulating material, and thus the positive electrode current collector was not exposed to the outside. Therefore, it can be seen that the short-circuit at the end surface of the positive electrode current collector can be effectively suppressed by the end surface covering portion.

On the other hand, in Comparative Example 1, the positive electrode current collector was not covered with the insulating material on the side end surface of the positive electrode current collector, and the positive electrode current collector was exposed to the outside. When the pressing by the roll press is not performed as described above, it is confirmed that the insulating frame of the positive electrode active material layer does not extend to the side end surface side of the positive electrode current collector and the end surface covering portion is not formed.

In addition, in Comparative Example 2, it can be seen that the positive electrode current collector was partially covered with the insulating material on the side end surface of the positive electrode current collector, but there was a portion exposed to the outside without being covered. Therefore, it has been confirmed that when the elongation percentage of the insulating material was not sufficient, the end surface covering portion was also incomplete, and the short circuit at the end surface of the positive electrode current collector could not be effectively suppressed.

From the above results, it was found that according to the present invention, it is possible to provide a positive electrode structure capable of suppressing a short circuit of a positive electrode current collector without using a base material for a solid electrolyte layer when the positive electrode structure is used as an all-solid-state battery.

Note that the present invention is not limited to the above-described embodiment, and can be implemented in various modes.

What is claimed is:

1. A positive electrode structure comprising: a foil-shaped current collector; and positive electrode active material layers provided on both surfaces of the current collector, wherein
each of the positive electrode active material layers has a central portion containing an active material and an insulating frame disposed on an outer periphery of the central portion and containing an insulating material having electrical insulation properties,
the insulating frame covers a surface near an outer edge of the current collector and at least a part of a side end surface of the current collector, and
the side end surface of the current collector covered with the insulating frame is covered with the insulating frame of the positive electrode active material layer provided on one of the surfaces of the current collector and the insulating frame of the positive electrode active material layer provided on the other of the surfaces of the current collector.

2. The positive electrode structure according to claim 1, wherein the insulating material of the insulating frame is alumina.

3. The positive electrode structure according to claim 1, wherein an elongation percentage of the insulating frame provided on the surfaces of the current collector is larger than an elongation percentage of the current collector.

4. A manufacturing method of the positive electrode structure according to claim 1, the manufacturing method comprising:
a first coating step of coating both surfaces of a metal foil sheet with a slurry of a positive electrode mixture containing the active material, a metal foil sheet being a raw material of the current collector;
a second coating step of coating a region along an outer periphery of the positive electrode mixture of the metal foil sheet with a slurry of the insulating material, at least a part of the region being along an outer edge of the metal foil sheet; and
a pressing step of roll-pressing the metal foil sheet coated with the slurry of the positive electrode mixture and the slurry of the insulating material at a pressing pressure from 800 MPa to 1200 MPa.

5. The manufacturing method of a positive electrode structure according to claim 4, wherein the slurry of the insulating material contains alumina, a styrene-butadiene rubber-based or polyvinylidene fluoride-based binder, and butyl butyrate.

6. The manufacturing method of a positive electrode structure according to claim 4, wherein an elongation percentage of the slurry of the insulating material in the pressing step is larger than an elongation percentage of the metal foil sheet.

7. A secondary battery comprising: the positive electrode structure according to claim 1 as a positive electrode.

8. The secondary battery according to claim 7, wherein the secondary battery is an all-solid-state battery.

9. The secondary battery according to claim 7, wherein the secondary battery is a lithium metal secondary battery.
